(19) United States
(12) Patent Application Publication
(10) Pub. No.: US 2003/0076159 A1
(43) Pub. Date: Apr. 24, 2003

(54) Stack element circuit

(76) Inventors: Joseph S. Shor, Tel Mond (IL); Eduardo Maayan, Kfar Saba (IL)

Correspondence Address: Eitan, Pearl, Latzer & Cohen Zedek, LLP., 10 Rockefeller Plaza, Suite 1001, New York, NY, 10020, US

(21) Appl. No.: 09/983,511

(22) Filed: Oct. 24, 2001

(51) Int. Cl. G05F 1/10

(52) U.S. Cl. 327/541

(57) ABSTRACT

A circuit including a reference element adapted to provide a reference current and having a control terminal and a first terminal, there being a voltage (V_{ct}) between the control terminal and the first terminal of the reference element, and a plurality of series-connected stack elements, each the stack element including a first terminal connected to a first voltage, and a control tern connected to a second terminal, the stack elements being adapted to receive at least one of the reference current and a multiple of the reference current, the stack elements and the reference element being matched such that a voltage between the control terminal and the first terminal of at least one of the stack elements is generally the same as V_{ct}.

### FIELD OF THE INVENTION

The present invention relates generally to circuitry for memory cell arrays, such as circuitry that may be used for voltage regulators for erasable, programmable read only memories (EPROMs), electrically erasable, programmable read only memories (EEPROMs), and flash EEPROM memories, for example.

### BACKGROUND OF THE INVENTION

Voltage regulators are circuits useful for providing accurate analog voltages for erasable, programmable read only memories (EPROMs) and other integrated circuits. A voltage regulator may typically comprise a reference voltage, a comparator, a driver and a resistor divider. An example of a prior art voltage regulator is shown in FIG. 1, and uses a so-called Miller architecture, well known in the art. A comparator GM1 is connected to the gate of a PMOS (p-channel metal oxide semiconductor) driver GM2. The comparator GM1 is supplied a supply voltage V_{PP}, and compares voltages IP and FB. The comparator GMI adjusts the gate voltage of the PMOS driver GM2 to equalize voltages IP and FB. The output voltage, OP, is thus a multiple of the input voltage, IP. The multiplication factor is determined by the resistor divider (RD) ratio between OP and FB.

A problem with this type of regulator is that a large current (typically >100 μA) is required across the resistor divider RD in order to establish the multiplication factor. It is possible to make this current arbitrarily small by increasing the resistance of the divider. However, this may have several undesirable effects. First, the drive capability of the regulator may be lowered. Second, increasing the resistance may require significant silicon area. Third, the speed of the feedback is a function of the current, and as such, lowering the current may substantially degrade the regulator's stability.

In EPROM applications, the V_{PP} supply (FIG. 1) is usually a pumped voltage. Pumping from the chip supply (V_{DD}) to a higher voltage (V_{PP}) is a process that has a low efficiency. Any current consumption from V_{PP} requires a significantly larger current consumption from V_{DD}, usually by a factor of 5-10. As such, it is critical to conserve current in regulators operating from a boosted source, such as those providing the wordline voltage in EPROMs. In the regulator of FIG. 1, the resistor divider drains current from the V_{PP} supply, such that a current of 100 μA required across the resistor divider may mean a V_{DD} current of 1 mA.

Accordingly, there is a need for a regulator that has a low current consumption from V_{PP} or another supply, while providing a high drive capability.

### SUMMARY OF THE INVENTION

The present invention seeks to provide a stack element circuit that may be used to provide an improved voltage regulator. The present invention may comprise stacked diode-connected transistors that receive a reference current or a multiple thereof from a reference element, which may be a reference transistor. Diode-connected transistors are transistors whose gate is connected to the drain. The diode-connected transistors and the reference element are preferably matched such that a gate-source voltage of the diode-connected transistors is generally the same as the gate-source voltage of the reference element.

There is thus provided in accordance with a preferred embodiment of the present invention a circuit including a reference element adapted to provide a reference current and having a control terminal and a first terminal, there being a voltage (V_{ct}) between the control terminal and the first terminal of the reference element, and a plurality of series-connected stack elements, each the stack element including a first terminal connected to a first voltage, and a control terminal connected to a second terminal, the stack elements being adapted to receive at least one of the reference current and a multiple of the reference current, the stack elements and the reference element being matched such that a voltage between the control terminal and the first terminal of at least one of the stack elements is generally the same as V_{ct}.

In accordance with a preferred embodiment of the present invention a voltage between the control terminal and the first terminal of each the stack element is generally the same as V_{ct}.

Further in accordance with a preferred embodiment of the present invention one of the first and second terminals comprises an input and the other of the first and second terminals comprises an output, and the output of a first stack element is connected to the input of a subsequent stack element.

Still further in accordance with a preferred embodiment of the present invention the reference element is at a voltage V_{DD} and the stack elements are at voltage V_{PP} wherein V_{PP}≧V_{DD}.

In accordance with a preferred embodiment of the present invention the stack elements include diode-connected transistors and the reference element includes a transistor, the diode-connected transistors and the reference element being matched such that a gate-source voltage of the diode-connected transistors is generally the same as V_{ct}.

Further in accordance with a preferred embodiment of the present invention the reference element is adapted to have a fixed V_{ct} voltage.

Still further in accordance with a preferred embodiment of the present invention the circuit includes a voltage regulator having an input and an output, wherein the input is a control terminal of the reference element, and the output is an output of a top transistor of the stack, the top transistor being the first of the diode-connected transistors that receives the reference current.

In accordance with a preferred embodiment of the present invention the first terminal includes an input and the second terminal includes an output.

In accordance with a preferred embodiment of the present invention the stack elements and the reference element include NMOS (n-channel metal oxide semiconductor) transistors, and the first terminal includes an input including at least one of a source and bulk, the control terminal includes a gate, and the second terminal includes an output including a drain.

Further in accordance with a preferred embodiment of the present invention the reference element receives a reference voltage at the control terminal and the output generates the reference current.

Still further in accordance with a preferred embodiment of the present invention the stack elements and the reference element include NMOS transistors, wherein for each NMOS transistor, a resistor is connected between a source of the transistor and the first terminal, a bulk of the transistor is connected to at least one of the source and the first terminal, the control terminal includes a gate, the first terminal comprises an input of the stack element and the second terminal includes an output including a drain.

Additionally in accordance with a preferred embodiment of the present invention an input of the reference element is at ground (GND).

In accordance with a preferred embodiment of the present invention an output of the circuit is the output of the top stack element, the top stack element being the first of the stack elements that receives the reference current.

Further in accordance with a preferred embodiment of the present invention a bottom stack element, the bottom stack element being the last of the stack elements that receives the reference current, receives a second reference voltage at its input.

Still further in accordance with a preferred embodiment of the present invention the stack elements and the reference element include NMOS transistors, and the first terminal includes an input including at least one of a source and bulk, the control terminal includes a gate, and the second terminal includes an output including a drain, wherein the reference element receives a reference voltage at the control terminal and the output generates the reference current, wherein an input of the reference element is at ground (GND), wherein an output of the circuit is the output of the top stack element, the top stack element being the first of the stack elements that receives the reference current, and wherein a bottom stack element, the bottom stack element being the last of the stack elements that receives the reference current, receives a second reference voltage at its input.

In accordance with another preferred embodiment of the present invention the first terminal includes an output and the second terminal includes an inputs Further in accordance with a preferred embodiment of the present invention the stack elements and the reference element include PMOS (p-channel metal oxide semiconductor) transistors, and the first terminal includes an output including at least one of a source and bulk, the control terminal includes a gate, and the second terminal includes an input including a drain.

Still further in accordance with a preferred embodiment of the present invention the stack elements and the reference element include PMOS transistors, wherein for each PMOS transistor, a resistor is connected between a source of the transistor and the first terminal, a bulk of the transistor is connected to at least one of the source and the first terminal, the control terminal includes a gate, the first terminal comprises an input of the stack element and the second terminal includes an input including a drain.

Additionally in accordance with a preferred embodiment of the present invention the control terminal and the input of the reference element are at GND.

In accordance with a preferred embodiment of the present invention a reference voltage is placed at the output of the reference element.

Further in accordance with a preferred embodiment of the present invention the control terminal of a bottom stack element the bottom stack element being the last of the stack elements that receives the reference current, receives a second reference voltage and the input of the bottom stack element is at GND.

Still further in accordance with a preferred embodiment of the present invention the stack elements and the reference element include PMOS transistors, and the first terminal includes an output including at least one of a source and bulk, the control terminal includes a gate, and the second terminal includes an input including a drain, wherein the control terminal and the input of the reference element are at GND, wherein a reference voltage is placed at the output of the reference element, wherein an output of the circuit is the output of the top stack element, the top stack element being the first of the stack elements that receives the reference current, and wherein the control terminal of a bottom stack element, the bottom stack element being the last of the stack elements that receives the reference current, receives a second reference voltage and the input of the bottom stack element is at GND.

In accordance with a preferred embodiment of the present invention the reference element is connected to the stack elements via a current mirror.

Further in accordance with a preferred embodiment of the present invention the current mirror includes at least two matched transistors.

Still further in accordance with a preferred embodiment of the present invention a voltage across the stack elements includes the V_{ct} multiplied by a number of the stack elements.

In accordance with a preferred embodiment of the present invention a first reference voltage (V_{REF}) is input to the reference element.

Further in accordance with a preferred embodiment of the present invention a second reference voltage is input to the stack elements.

Still further in accordance with a preferred embodiment of the present invention the second reference voltage includes the first reference voltage divided by a voltage divider.

Additionally in accordance with a preferred embodiment of the present invention the second reference voltage is equal to the first reference voltage divided by a predetermined factor Y, and wherein an output OP of the circuit is given by OP=(S×V_{REF})+(V_{REF}/Y) wherein S=the number of stack elements.

In accordance with a preferred embodiment of the present invention the voltage divider includes a resistor divider. The resistor divider may be buffered by a buffer. The output of the buffer may be input to the stack elements. The resistor divider may include a variable resistor divider or a digitally controlled resistor divider, for example.

Further in accordance with a preferred embodiment of the present invention there is a shunting path to at least one of the stack elements.

There is also provided in accordance with a preferred embodiment of the present invention a driver including fist and second PMOS transistors, first and second NMOS transistors, and first and second current sources, wherein a gate and a drain of the first PMOS transistor are connected to the first current source, and the first current source is grounded, and wherein a source of the first PMOS transistor is connected to a source of the first NMOS transistor, the first NMOS transistor having its gate and its drain connected to the second current source, the second current source being connected to a supply voltage, and wherein gates of the NMOS transistors are connected to each other, and gates of the FMOS transistors are connected to each other, and wherein a drain of the second NMOS transistor is connected to the supply voltage and a source of the second NMOS transistor is connected to an output of the driver, and wherein a drain of the second PMOS transistor is connected to GND, and a source of the second PMOS transistor is connected to the output of the driver.

In accordance with a preferred embodiment of the present invention the first and second current sources are derivable from a reference current.

Further in accordance with a preferred embodiment of the present invention the first and second current sources are generally equal.

Still further in accordance with a preferred embodiment of the present invention an input to the driver is connected to an output of a circuit including a reference element adapted to provide a reference current and having a control terminal and a first terminal, there being a voltage (V_{ct}) between the control terminal and the first terminal of the reference element, and a plurality of series-connected stack elements, each the stack element including a fist terminal connected to a first voltage, and a control terminal connected to a second terminal, the stack elements being adapted to receive at least one of the reference current and a multiple of the reference current, the stack elements and the reference element being matched such that a voltage between the control terminal and the first terminal of at least one of the stack elements is generally the same as V_{ct}, wherein a first reference voltage (V_{REF}) is input to the reference element, and wherein a second reference voltage is input to the stack elements.

There is also provided in accordance with a preferred embodiment of the present invention a circuit including a reference element adapted to receive a first reference voltage and provide a reference current, and a plurality of series-connected stack elements adapted to receive the reference current and provide a multiple of the fist reference voltage, wherein the multiple is a function of the number of the stack elements.

### BRIEF DESCRIPTION OF THE DRAWINGS

The present invention will be understood and appreciated more fully from the following detailed description taken in conjunction with the appended draw in which:

FIG. 1 is a schematic illustration of a prior art voltage regulator;

FIG. 2 is a schematic illustration of a general circuit comprising stack elements, which may be used as a voltage regulator circuit, constructed and operative in accordance with a preferred embodiment of the present invention;

FIG. 3 is a schematic illustration of a voltage regulator constructed and operative in accordance with a preferred embodiment of the present invention, and using NMOS transistors;

FIG. 4 is a schematic illustration of the voltage regulator of FIG. 3, illustrating diode-connected transistor circuitry, circuitry of a driver, and a circuit to generate a V_{OFFSET} input used in the regulator of FIG. 3;

FIG. 5 is a schematic illustration of another version of the voltage regulator of FIG. 3, constructed and operative in accordance with another preferred embodiment of the present invention, and including digital control of the V_{OFFSET} input and the number of stack elements in the circuit;

FIG. 6 is a graphical illustration of a rise and fall of an output voltage of the voltage regulator of FIG. 5, in accordance with a preferred embodiment of the present invention;

FIG. 7 is a schematic illustration of yet another version of the voltage regulator of FIG. 3, constructed and operative in accordance with yet another preferred embodiment of the present invention, and including PMOS transistors;

FIGS. 8 and 9 are schematic illustrations of stack elements of the general circuit of FIG. 2, which comprises NMOS transistors, in accordance with a preferred embodiment of the present invention, respectively without and with a resistor, and

FIGS. 10 and 11 are schematic illustrations of stack elements of the general circuit of FIG. 2, which comprises PMOS transistors, in accordance with a preferred embodiment of the present invention, respectively without and with a resistor.

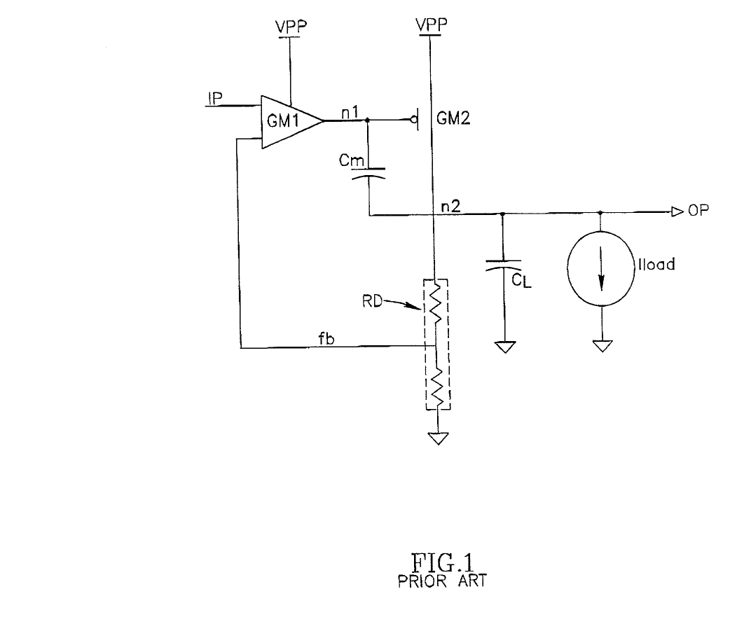

### DETAILED DESCRIPTION OF THE PRESENT INVENTION

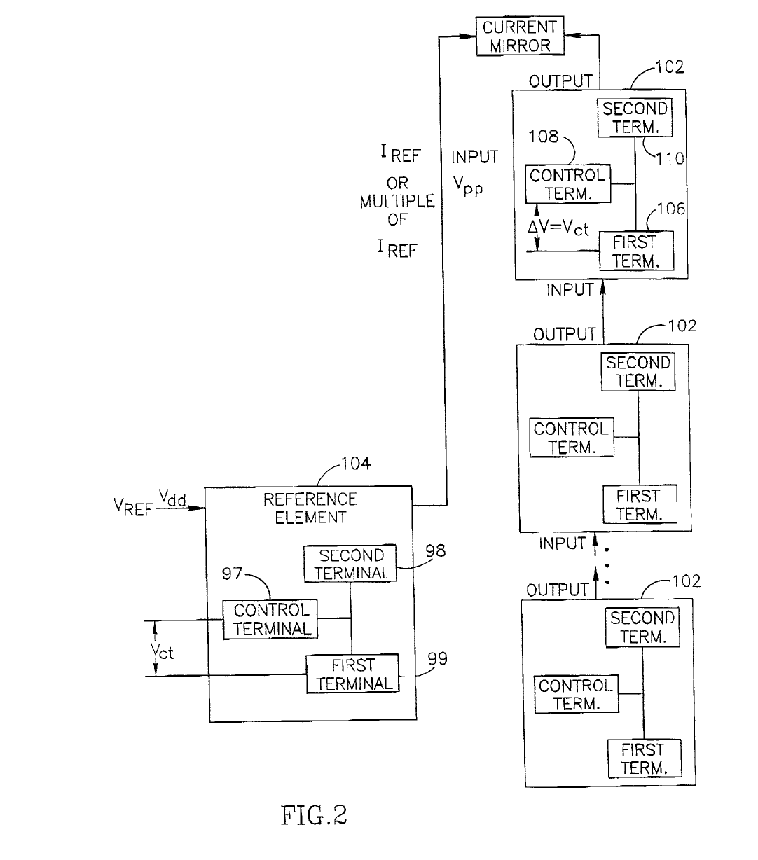

Reference is now made to FIG. 2, which illustrates a circuit 100 comprising stack elements 102, which may be used as a voltage regulator circuit, con d and operative in accordance with a preferred embodiment of the present invention.

The circuit 100 may include a reference element 104 adapted to provide a reference current (I_{ref}) and having a control terminal 97, a first terminal 99 and a second terminal 98, there being a voltage (V_{ct}) between the control terminal 97 and the first terminal 99 of reference element 104. Reference element 104 may comprise an NMOS transistor, in which case control terminal 97 comprises a gate of the transistor, second terminal 98 comprises a drain of the transistor, first terminal 99 comprises a source of the transistor and V_{ct} is the gate-source voltage (V_{gs}).

A plurality of series-connected stack elements 102 is preferably provided, wherein each stack element 102 comprises a first terminal 106, and a control terminal 108 connected to a second terminal 110. The stack elements 102 may receive the reference current I_{ref} or a multiple thereof. The stack elements 102 and the reference element 104 are preferably matched. Two elements are considered “tcatched” if their lengths are substantially equal, and if their widths and current are either substantially equal or are the same multiple hereof The stack elements 102 and the reference element 104 are preferably matched such that the voltage between the control terminal 108 and the first terminal 106 of one or all of the stack elements 102 is generally the same as the V_{ct} of the reference element 104. (It is noted again that if reference element 104 is a transistor, then V_{ct}=V_{gs}) The output of a first stack element 102 is connected to the input of a subsequent stack element 102. The reference element 104 may be at a voltage V_{dd} and the stack elements may be at voltage Vₚₚ wherein Vₚₚ≧V_{dd}.

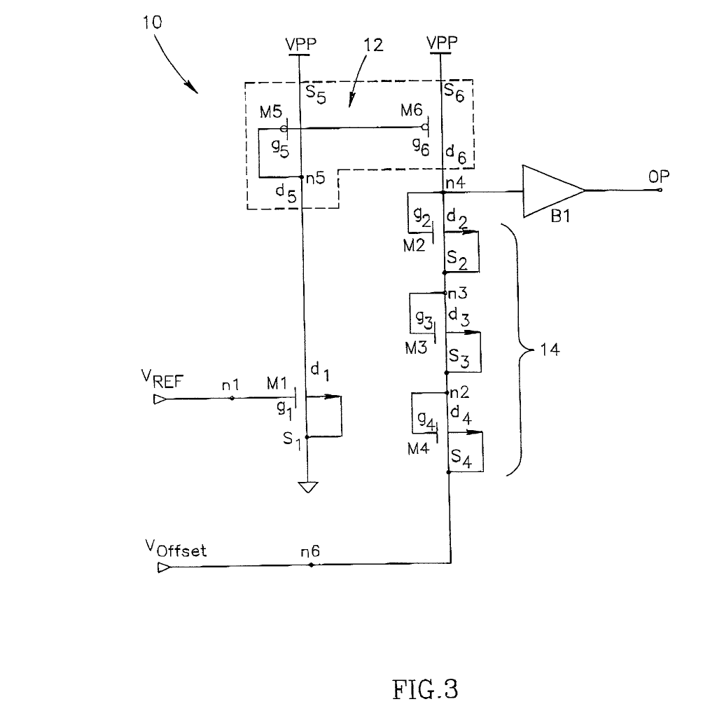

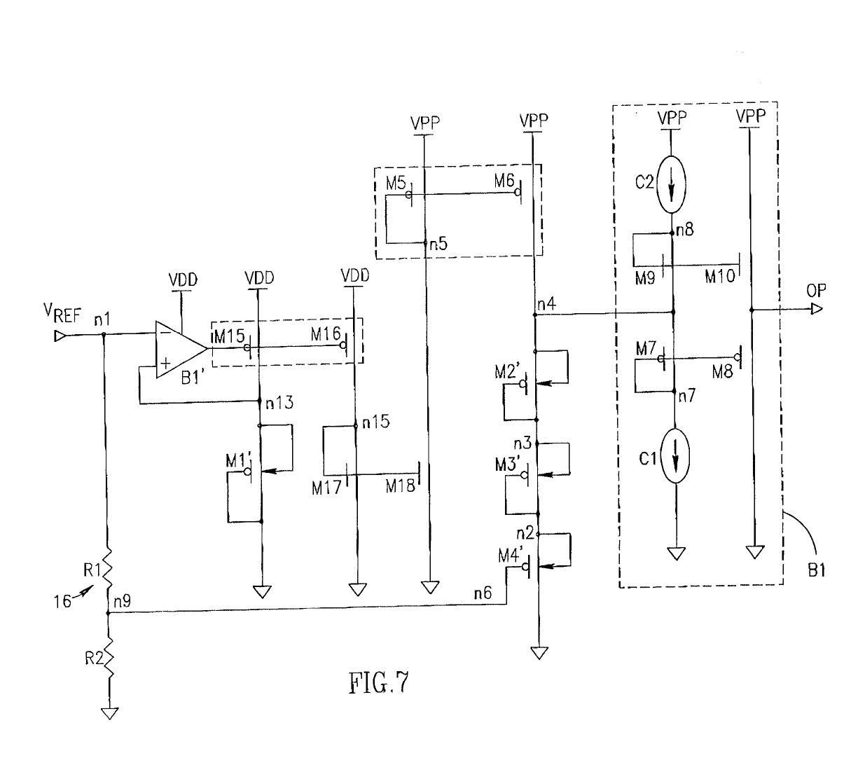

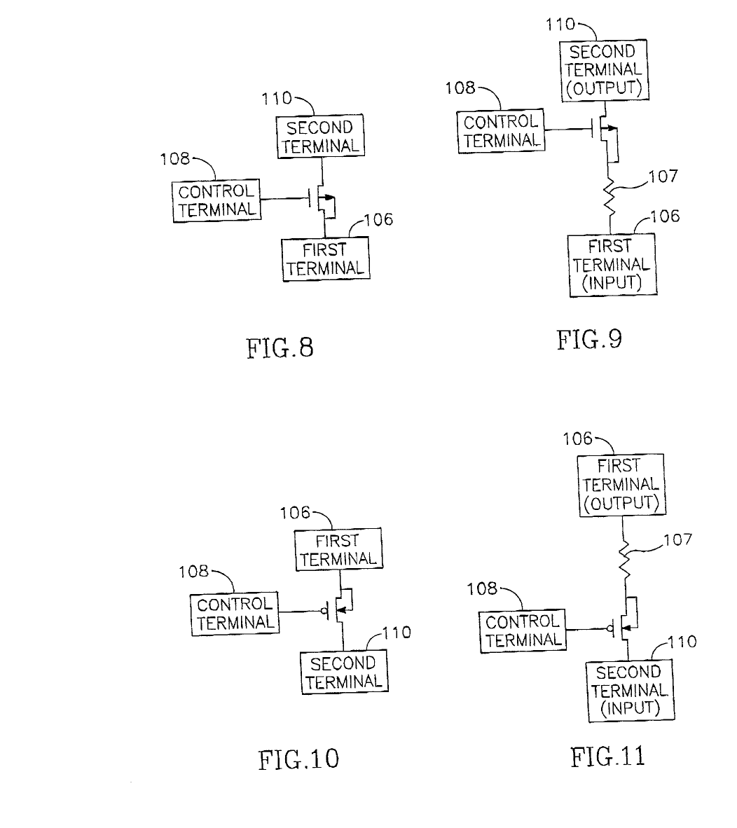

The circuit 100 may be implemented in several ways in accordance with the present invention. More detailed examples of a circuit wherein the stack elements 102 and the reference element 104 comprise NMOS transistors are described hereinbelow with reference to FIGS. 3-6. A more detailed example of a circuit wherein the stack elements 102 and the reference element 104 comprise PMOS transistors is described hereinbelow with reference to FIG. 7. Two simplified and general examples of Circuits comprising NMOS transistors without and with a resistor are described hereinbelow with reference to FIGS. 8 and 9. Two simplified and general examples of circuits comprising PMOS transistors without and with a resistor are described hereinbelow with reference to FIGS. 10 and 11.

Reference is now made to FIG. 3, which illustrates an implementation of the circuit 100 of FIG. 2 in a voltage regulator 10 constructed and operative in accordance with a preferred embodiment of the present invention.

A reference voltage V_{REF} may be input via a circuit node n₁ into a gate g₁ of an NMOS reference element M1. A source s₁ and bulk of M1 are connected to GND. A drain d₁ of M1 is connected at a circuit node n₅ to a drain d₅ and a gate g₅ of a PMOS transistor M5, whose source s₅ and bulk are at V_{PP}. The gate g₅ of M5 is connected to a gate g₆ of a PMOS transistor M6, whose source s₆ and bulk are at V_{PP}. A drain d₆ of M6 is connected at a circuit node 114 to a gate g₂ and a drain d₂ of an NMOS transistor M2. A source s₂ and bulk of M2 are connected through a circuit node n₃ to a gate g₃ and a drain d₃ of an NMOS transistor M3. A source s₃ and bulk of M3 are connected at a circuit node n₂ to a gate g₄ and a drain d₄ of an NMOS transistor M4. A source s₄ and bulk of M4 may be connected at a circuit node n₆ to a second input (a second reference voltage) V_{OFFSET}. Circuit node n₄ is also connected to an input of a driver B1, whose output is an output of a regulator OP. Transistors M5 and M6 form a current mirror 12. A current mirror is defined as a circuit element or portion of a circuit that receives an input current and outputs the same input current or a multiple thereof.

In accordance wit a preferred embodiment of the present invention, the circuit of FIG. 3 is manufactured in a process that allows independent control of the NMOS bulk voltages. Examples of such processes are triple well processes, and silicon-on-insulator.

One operation of the circuit in accordance with an embodiment of the invention is as follows. The input reference voltage V_{REF}, which may typically be at a value of 1.3V, several 100 mV above the NMOS threshold voltage, is input to the gate g₁ of M1. M1 then acts as a current source at its drain d₁ providing a reference current I_{ref}, which may typically be 5-10 kA. This current may be subject to process variations, but these generally do not affect the output voltage.

The current I_{ref} is fed into the current mirror 12 formed by transistors M5 and M6. If transistors M5 and M6 are matched, the current at the drain d₆ of M6 is I_{ref}, or in general, at least a multiple thereof. The NMOS transistors M1, M2, M3 and M4 are all preferably matched. Since transistors M2, M3 and M4 are all diode connected (i.e., gate connected to drain) and have generally the same current as M1, their gate-source voltage (V_{gs}) is generally the same as the gate-source voltage of M1.

The transistors M2, M3 and M4 form a “stack” 14, that is, a plurality of series-connected stack elements, wherein each of transistors M2, M3 and M4 is a stack element. The voltage across stack 14 is the gate-source voltage V_{gs} multiplied by the number of transistors in the stack 14. In the illustrated embodiment, for example, since there are three transistors in the stack 14, the voltage between nodes n₄ and n₆ is three times V_{REF}. If a second reference voltage source, also referred to as an offset voltage V_{OFFSET}, is added at node n₆, the voltage at n₄ and OP is 3×V_{REF}+V_{OFFSET}. V_{OFFSET} may be equal to V_{REF} divided by a predetermined factor Y, as described hereinbelow. The value of OP may be increased/decreased by increasing/decreasing the number of transistors in the stack 14. In more general terms:

OP=(S×V_{REF})+(V_{REF}/Y) (1)

where S=the number of transistors in the stack 14 and Y is the divider ratio between V_{REF} and V_{OFFSET}.

In principle, any output voltage may be achieved by varying the number of transistors in the stack 14 and the divider ratio between V_{REF} and V_{OFFSET}. The driver B1 may be a class AB driver, which can drive the output strongly while using minimal quiescent current.

In accordance with embodiments described herein, transistor M2 is the “top” stack element, i.e., the first stack element to receive the reference current, and transistor M4 is the “bottom” stack element, i.e., the last stack element to receive the reference current.

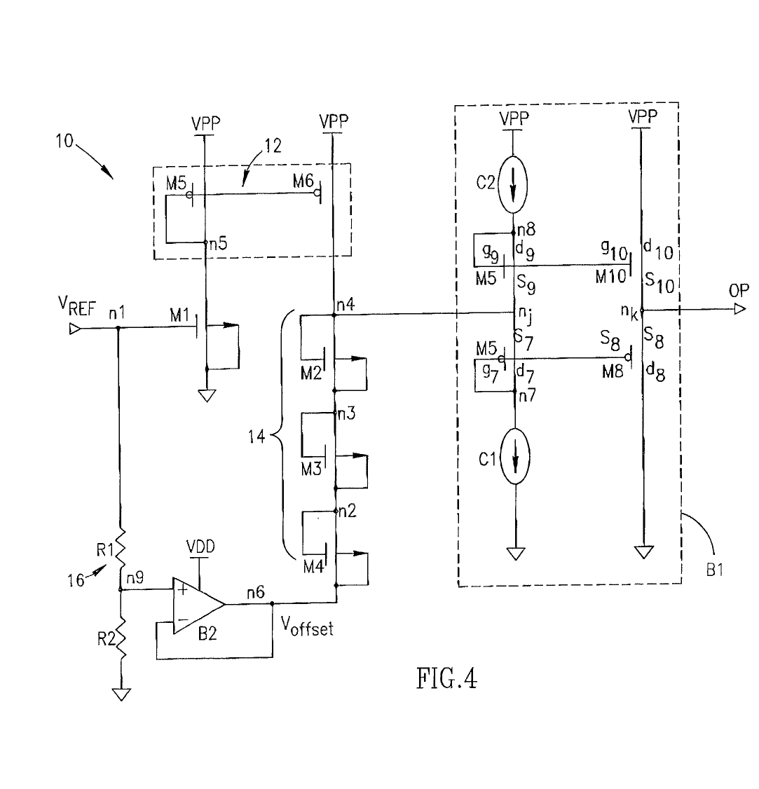

A more detailed version of the first embodiment is shown in FIG. 4. This schematic includes the circuit of FIG. 3, detailed circuitry of driver B1, as well as a circuit to generate the V_{OFFSET} input.

In the embodiment of FIG. 4, the driver B1 is formed by PMOS transistors M7 and M8, NMOS transistors M9 and M10, and current sources C1 and C2. A gate g₇ and a drain d₇ of M7 are connected via a circuit node n₇ to current source C1. Current source C1 is grounded to GND. A source S7 of M7 is connected at a circuit node nⱼ to a source s₉ of transistor M9. The gate g₉ of M9 and its drain d₉ are connected to current source C2 via a circuit node no. The current source C2 is connected to V_{PP}. The gate g₉ of M9 is connected to a gate g₁₀ of transistor M10, whose drain d₁₀ is connected to V_{PP} and whose source s₁₀ is connected to OP via a circuit node nₖ. A gate g₈ of M8 is connected to the gate g₇ of transistor M7. A source s₈ of M8 is connected to node nₖ, and a drain d₈ of M8 is connected to GND.

The circuit to generate the V_{OFFSET} input preferably comprises a resistor divider 16. Resistor divider 16 may comprise, without limitation, a resistor R1 connected to V_{REF} via circuit node n₁, and to a resistor B2 at circuit node 19, Resistor R2 is grounded to GND. A buffer B2 bas a positive input connected to node n₉, and a negative input connected to node n₆, which, as described hereinabove, is connected to source s₄ and bulk of M4.

In the driver B1 of FIG. 4, transistors M7, M8, M9 and M10 and current sources C1 and C2 preferably have equal current and are matched. C1 and C2 may be derived from I_{ref}, or from another current reference. The current flowing in the stack 14 formed by transistors M2, M3, and M4 is generally unaffected by the presence of the current in current sources C1 and C2, because the two current sources compensate for each other. Thus, the voltage at n4 is still defined by equation 1.

Transistor M9 is diode connected, such that:

V(n₈)=V(n₄)+Vₜ+V_{dsat} (2)

where Vₜ is the threshold voltage of transistor M9 and V_{dsat} is the degree to which the transistor M9 is turned on beyond the threshold, According to basic MOSFET physics, the drain current I_{d} is described by;

I_{d}=k′W/L(V_{dsat})² (3)

where k′ is a process parameter, W and L are the width and length of the MOSFET and

V_{dsat}=V_{gs}−Vₜ (4)

with V_{gs} being the gate-source voltage.

Similarly, transistor M7 is diode connected and

V(n₇)=V(n₄)−Vₜ−V_{dsat} (5)

Transistors M8 and M10 are preferably back-to-back source followers and are matched with M7 and M9, respectively. The symmetry between the four transistors M7, Mg, M9 and M10 causes:

a) OP to be generally at the same voltage as n₄ in steady state,

b) the current flowing in the M7, M9 branch to be generally equal to that in the M8, M10 branch in steady state, and

c) V_{dsat}(M8) to be generally equal to V_{dsat}(M7), and V_{dsat}(M9) to be generally equal to V_{dsat}(M10) in steady state.

If the voltage at OP differs from n4, then the V_{dsat} of one of transistors M9 and M10 increases, whereas the V_{dsat} of the other transistor (M8 or M10) decreases, in accordance with equation 4. This results in a large current (in accordance with equation 3), which restores the equality between n₄ and OP. Thus the drive capability at OP may be very high. However, the quiescent currents of the circuit of FIG. 4 may be very low (˜20-30 μA).

The V_{offset} input supplied at the source of M4 may be generated by resistor divider 16 from V_{ref}, which may be buffered by B2. It is noted that B2 may have V_{DD} as the supply such tat the current drains caused by the buffer and the resistor divider 16 are less costly than those in the prior art.

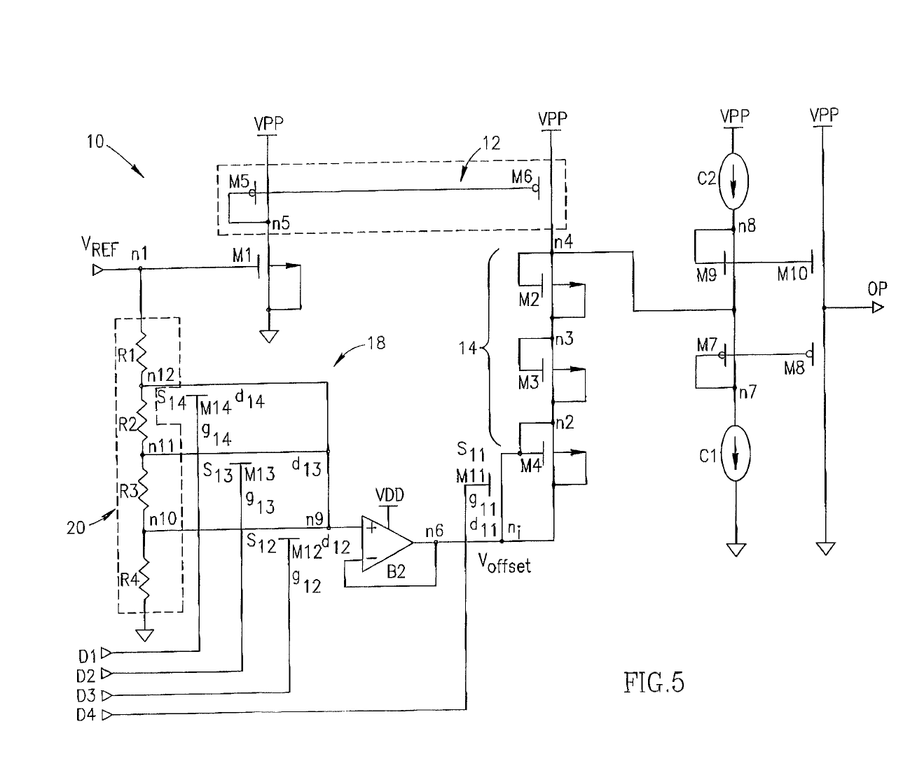

A further enhancement of the voltage regulator of FIG. 3 or FIG. 4 is now described with reference to FIG. 5, which includes digital control circuitry 18.

Digital control circuitry 1 to generate the V_{OFFSET} input preferably comprises a resistor divider 20 that may comprise, without limitation, a resistor R1 connected to V_{REF} via circuit node n₁, and to a resistor R2 at a circuit node n₁₂. Resistor R2 is connected to a resistor R3 at a circuit node n₁₁, and resistor R3 is connected to a resistor R4 via a circuit node n₁₀. Resistor R4 is grounded to GND. An NMOS transistor M14 has its source 514 connected to node n12, its gate g94 connected to a digital input D1, and its drain d₁₄ connected to node n₉ via a circuit node nₘ. An NMOS transistor M13 has its source s₁₃ connected to node n₁₁, its gate g₁₃ connected to a digital input D2, and its drain d₁₃ connected to node n₉ via node nₘ. An NMOS transistor M12 has its source s₁₂ connected to node n₁₀, its gate g₁₂ connected to a digital input D3, and its drain d₁₂ connected to node n₉. As described hereinabove with reference to FIG. 4, buffer 12 has a positive input connected to node n₉, and a negative input connected to node n₆, which is connected to source s₄ and bulk of M4. An NMOS transistor M11 has its source S₁₁ connected to the gate g₄ of transistor M4, its gate g₁₁ connected to a digital input D4, and its drain d₁₁ connected to node n₆ via a circuit node nᵢ.

In the embodiment of FIG. 5, digital inputs D1, D2, and D3 turn on/off transistors M12, M13, and M14, thus determining which voltage along the resistor divider 20 is input to buffer B2. Id this manner, the V_{OFFSET} may be digitally controlled to be an arbitrary value between VRBF and GND, determined by the amount of digital inputs and transistors used. When the digital input D4 is enabled, transistor M11 shunts the V_{gs} of transistor M4. Thus, the number of transistors in the diode stack 14 may also be determined digitally, The embodiment of FIG. 5 allows digital control of the S and Y values in equation 1 for a given regulator. In an EPROM device, this may be a very useful feature to allow different trim levels for the wordline voltage.

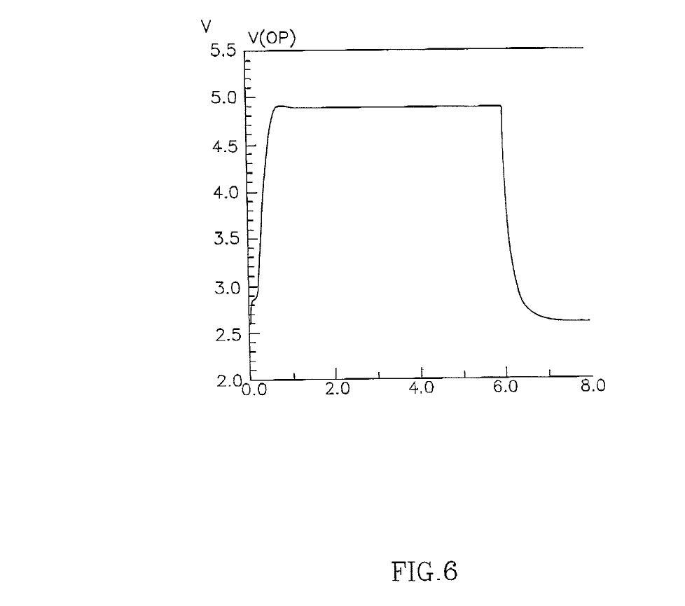

Reference is now made to FIG. 6, which illustrates a SPICE simulation of the rise and fall of OP for the circuit in FIG. 5. In the example of FIG. 6, OP is driven from V_{DD} (2.6V) to 4.9V and back to V_{DD}. The values of V_{REF} and V_{OFFSET} are 1.3V and 1V respectively. The output capacitance is 50 pF. The regulator raises V(OP) to its final value in <1 μs. This requires currents in the mA range. The quiescent current is 30 μA, typical of class AB operation. It is emphasized-that these are only exemplary values, and the present invention is not limited to these values.

The circuits shown in FIGS. 3-5 all use NMOS transistors in the V_{gs} stack and to generate I_{ref}. However, in order to have good V_{gs} matching between these transistors, it may be preferable to have independent control of the bulk voltage. In most CMOS process, all of the NMOS bulks may be permanently grounded, such that the V_{gs} voltages in the stack may differ as a result of the bulk effect. For these processes, it is possible to implement the regulator with another embodiment of the present invention, which uses PMOS transistors for the reference current and the V_{gs} stack, as is now described with reference to FIG. 7.

A gate g₁, and a drain d₁ of a PMOS reference element M1′ are connected to GND. A source s_{1′} of M1′ is connected at a circuit node n₁₃ to the positive input of a comparator B1′ and to its bulk. A drain d₁₅ of a PMOS transistor M15 is connected to node n₁₃. A gate g₁₅ of Ml5 is connected to output of comparator B1′ at a node n₁₄, and to a gate g₁₆ of a PMOS transistor M16. A source s₁₅ of M15 is connected to V_{DD}. A source s₁₆ of M16 is connected to V_{DD}. A gate g₁₇ and a drain d₁₇ of an NMOS transistor M17 are connected to a drain d₁₆ of Resistor M16 at a node n₁₅. A source s₁₇ of M17 is grounded to GND. The gate g₁₇ of M17 is connected to a gate g₁₈ of an NMOS transistor M18, whose source s₁₈ is grounded to GND. A drain d₁₈ of M18 is connected at node n₅ to the drain d₅ of PMOS transistor M5. Some of the transistors form current mirrors. For example, transistors M5 and M6 form a current mirror, transistors M15 and M6 form a current mirror, wherein transistor M15 is also used to generate the voltage at node n₁₃; transistors M17 and M18 form a current mirror; and the combination of transistors M5, M6, M15, M16, M17 and M18 forms a current mirror that receives an input cement from the reference element and outputs the same input current or a multiple hereof to the stack elements.

The drain d₆ of M6 is connected at node n₄ to a source and bulk s_{2′} of a PMOS transistor M2′. A gate g_{2′} and a drain d_{2′} of transistor M2′ are connected through node n₃ to a source and bulk s₃, of a PMOS transistor M3′. A gate g_{3′} and a drain d_{3′} of transistor M3′ are connected through node n₂ to a source and bulk s₄ of a PMOS transistor M4′. A gate g_{4′} of transistor M4′ is connected through node n₆ to node n₉, to which are connected resistors R1 and R2 of resistor divider 16. As described hereinabove with reference to FIG. 4, resistor divider 16 may comprise without limitation resistor R1 connected to V_{REF} via node n₁, and to resistor R2 at node n₉. Resistor R2 is grounded to GND. Comparator B1′ has a positive input connected to node n₁₃, and a negative input connected to node n₁. Comparator B1′ receives V_{DD}. Driver B1 is connected to node n₄ as described hereinabove with reference to FIG. 4.

The reference current, I_{ref} is generated across PMOS transistor M1′ in the embodiment of FIG. 7. Transistor M1′ is connected as a diode (gate to drain), and its source is driven by M15 at node n₁₃. The source voltage of M1′ is fed back to the positive input of comparator B1′, which has its negative input at V_{REF}. The operational amplifier formed by B1′ and M15 equalizes the positive and negative inputs, such that V(n₁₃)=V_{REF}. The current in M1′ (I_{ref}) is mirrored through transistors M16, M17, MI8, M5 and M6 to the V_{gs} diode stack 14′ formed by M2′, M3′ and M4′. The voltage between the gate of M4′ and the source of M2′ is 3×V_{REF}, since M1′, M2′, M3′ and M4′ are matched in current and dimension. In addition, the offset voltage may be driven to the gate of M4 by the resistor divider 16 from V_{REF}, such that the voltage at n₄ is defined by equation 1. The output buffer (i.e., driver) that is formed by current sources C1 and C2 and by transistors M7-M10 is generally identical to that shown in FIGS. 4 and 5. In principle, any output buffer (driver) may be used in the embodiment of FIG. 7, if and when necessary. The digital enhancements shown in FIG. 5 may also be implemented in the embodiment of FIG. 7. The circuit of FIG. 7 obeys equation (1).

As mentioned hereinabove, the circuit 100 may be implemented without and with a resistor in accordance with the present invention. For example, as shown in FIG. 8, the stack elements 102 and the reference element 104 of circuit 100 may comprise NMOS transistors. In such an embodiment, the control terminal 108 comprises the gate of the NMOS transistor, the first terminal 106 comprises the input which is the source and bulk of the NMOS transistor, and the second terminal 110 comprises the output which is the drain of the NMOS transistor, as described hereinabove with reference to the embodiment shown in FIG. 3.

Referring to FIG. 9, a resistor 107 may be connected between the source of the NMOS transistor and the first terminal 106. The bulk may be connected either to the source or the first terminal 106. Resistor 107 is preferably connected this way in the stack elements 102 and the reference element 104.

Reference is now made to FIG. 10, which illustrates another embodiment of the circuit 100, wherein the stack elements 102 and the reference element 104 comprise PNOS transistors. In such an embodiment, the fast terminal 106 comprises an output comprising at least one of the source and bulk of the PMOS transistor, the control terminal 108 comprises the gate of the PMOS transistor, and the second terminal 110 comprises the input comprising the drain of the PMOS transistor, as described hereinabove with reference to the embodiment of FIG. 7.

Referring to FIG. 11, a resistor 107 may be connected between the source of the PMOS transistor and the first terminal 106. The bulk may be connected either to the source or the first terminal 106. Resistor 107 is preferably connected this way in the stack elements 102 and the reference element 104.

Connecting resistor 107 between the source of the transistor and the first terminal 106, as in FIGS. 9 and 11, may achieve a more uniform temperature coefficient of current for the reference and stack elements. In other words, the reference and stack currents may be more uniform over a wide range of temperature.

It will be appreciated by persons skilled in the art that the present invention is not limited by what has been particularly shown and described herein above. Rather the scope of the invention is defined by the claims that follow:

What is claimed is:

1. A circuit comprising:
a reference element adapted to provide a reference current and having a control terminal and a first terminal there being a voltage (V_{ct}) between said control terminal and said first terminal of said reference element; and
a plurality of series-connected stack elements, each said stack element comprising a first terminal connected to a first voltage, and a control terminal connected to a second terminal, said stack elements being adapted to receive at least one of said reference current and a multiple of said reference current, said stack elements and said reference element being matched such that a voltage between said control terminal and said first terminal of at least one of said stack elements is generally the same as V_{ct}.

2. The circuit according to claim 1 wherein a voltage between said control terminal and said first terminal of each said stack element is generally the same as V_{ct}.

3. The circuit according to claim 1 wherein one of said first and second terminals comprises an input and the other of said first and second terminals comprises an output, and the output of a first stack element is connected to the input of a subsequent stack element.

4. The circuit according to claim 1 wherein said reference element is at a voltage V_{dd} and said stack elements are at voltage Vₚₚ wherein Vₚₚ≧V_{dd}.

5. The circuit according to claim 3 wherein said stack elements comprise diode-connected transistors and said reference element comprises a transistor, said diode-connected transistors and said reference element being matched such that a gate-source voltage of said diode-connected transistors is generally the same as V_{ct}.

6. The circuit according to claim 5 wherein said reference element is adapted to have a fixed V_{ct} voltage.

7. The circuit according to claim 5 wherein said circuit comprises a voltage regulator having an input and an output, wherein said input is a control terminal of said reference element, and said output is an output of a top transistor of said stack, said top transistor being the first of said diode-connected transistors that receives said reference current.

8. The circuit according to claim 3 wherein said first terminal comprises an input and said second terminal comprises an output.

9. The circuit according to claim 3 wherein said stack elements and said reference element comprise NMOS (n-channel metal oxide semiconductor) transistors, and said first terminal comprises an input comprising at least one of a source and bulk, said control terminal comprises a gate, and said second terminal comprises an output comprising a drain.

10. The circuit according to claim 9 wherein said reference element is connected to a reference voltage at said control terminal and said output generates said reference current.

11. The circuit according to claim 3 wherein said stack elements and said reference element comprise NMOS transistors, wherein for each NMOS transistor, a resistor is connected between a source of said transistor and said first terminal, a bulk of said transistor is connected to at least one of the source and said first terminal, said control terminal comprises a gate, said first terminal comprises an input of said stack element and said second terminal comprises an output comprising a drain.

12 The circuit according to claim 9 wherein an input of said reference element is at ground (GND).

13. The circuit according to claim 9 wherein an output of said circuit is the output of the top stack element, said top stack element being the first of said stack elements that is connected to said reference current.

14. The circuit according to claim 9 wherein a bottom stack element, said bottom stack element being the last of said stack elements that receives said reference current, is connected to a second reference voltage at its input.

15. The circuit according to claim 3 wherein said stack elements and said reference element comprise NMOS transistors, and said first terminal comprises an input comprising at least one of a source and bulk, said control terminal comprises a gate, and said second terminal comprises an output comprising a drain;
wherein said reference element is connected to a reference voltage at said control terminal and said output generates said reference current;
wherein an input of said reference element is at ground (GND);
wherein an output of said circuit is the output of the top stack element, said top stack element being the first of said stack elements that is connected to said reference current; and
wherein a bottom stack element, said bottom stack element being the last of said stack elements that is connected to said reference current, receives a second reference voltage at its input.

16. The circuit according to claim 3 wherein said first terminal comprises an output and said second terminal comprises an input.

17. The circuit according to claim 3 wherein said stack elements and said reference element comprise PMOS (p-channel metal oxide semiconductor) transistors, and said first terminal comprises an output comprising at least one of a source and bulla said control terminal comprises a gate, and said second terminal comprises an input comprising a drain.

18. The circuit according to claim 3 wherein said stack elements and said reference element comprise PMOS transistors, wherein for each PMOS transistor, a resistor is connected between a source of said transistor and said first terminal, a bulk of said transistor is connected to at least one of the source and said first terminal, said control terminal comprises a gate, said first terminal comprises an output of said stack element and said second terminal comprises an input comprising a drain.

19. The circuit according to claim 17 wherein said control terminal and the input of said reference element are at GND.

20. The circuit according to claim 19 wherein a reference voltage is placed at the output of said reference element.

21. The circuit according to claim 17 wherein the control terminal of a bottom stack element, said bottom stack element being the last of said stack elements that receives said reference current, receives a second reference voltage and the input of said bottom stack element is at GND.

22. The circuit according to claim 3 wherein said stack elements and said reference element comprise PMOS transistors, and said first terminal comprises an output comprising at least one of a source and bulk, said control terminal comprises a gate, and said second terminal comprises an input comprising a drain;
wherein said control terminal and the input of said reference element are at GND;
wherein a reference voltage is placed at said output of said reference element;
wherein an output of said circuit is the output of the top stack element, said top stack element being the first of said stack elements that receives said reference current; and
wherein the control terminal of a bottom stack element, said bottom stack element being the last of said stack elements that receives said reference current, receives a second reference voltage and the input of said bottom stack element is at GND.

23. The circuit according to claim 1 wherein said reference element is connected to said stack elements via a current mirror.

24. The circuit according to claim 23 wherein said current mirror comprises at least two matched transistors.

25. The circuit according to claim 1 wherein a voltage across said stack elements comprises said V_{ct} multiplied by a number of said stack elements.

26. The circuit according to claim 1 wherein a fist reference voltage (V_{REF}) is input to said reference element.

27. The circuit according to claim 26 wherein a second reference voltage is input to said stack elements.

28. The circuit according to claim 27 wherein said second reference voltage comprises said fist reference voltage divided by a voltage divider.

29. The circuit according to claim 27 wherein said second reference voltage is equal to said first reference voltage divided by a predetermined factor Y, and wherein an output OP of said circuit is given by.
OP(S×V_{REF})+(V_{REF}/Y) wherein S=the number of stack elements.

30. The circuit according to claim 28 wherein said voltage divider comprises a resistor divider.

31. The circuit according to claim 30 wherein said resistor divider is buffered by a buffer.

32. The circuit according to claim 31 wherein an output of said buffer is input to said stack elements.

33. The circuit according to claim 30 wherein said resistor divider comprises a variable resistor divider.

34. The circuit according to claim 30 wherein said resistor divider comprises a digitally controlled resistor divider.

35. The circuit according to claim 30 wherein said resistor divider is buffered by a buffer, and said resistor divider comprises a digitally controlled resistor divider, wherein an output of said resistor divider is input to said buffer.

36. The circuit according to claim 34 and comprising a shunting path to at least one of said stack elements.

37. A driver comprising:
first and second PMOS transistors, first and second NMOS transistors, and first and second current sources, wherein a gate and a drain of said first PMOS transistor are connected to said first current source, and said first current source is grounded;
and wherein a source of said first PMOS transistor is connected to a source of said first NMOS transistor, said first NMOS transistor having its gate and its drain connected to said second current source, said second current source being connected to a supply voltage;
and wherein gates of said NMOS transistors are connected to each other, and gates of said PMOS transistors are connected to each other;
and wherein a drain of said second NMOS transistor is connected to said supply voltage and a source of said second NMOS transistor is connected to an output of said driver;
and wherein a drain of said second PMOS transistor is connected to GND, and a source of said second PMOS transistor is connected to the output of said driver.

38. The driver according to claim 37 wherein said first and second current sources are derivable from a reference current.

39. The driver according to claim 37 wherein said first and second current sources are generally equal.

40. The driver according to claim 37 wherein an input to said driver is connected to an output of a circuit comprising:
a reference element adapted to provide a reference current and having a control terminal and a first terminal, there being a voltage (V_{ct}) between said control terminal and said first terminal of said reference element; and
a plurality of series-connected stack elements, each said stack element comprising a first terminal connected to a first voltage, and a control terminal connected to a second terminal, said stack elements being adapted to receive at least one of said reference current and a multiple of said reference current, said stack elements and said reference element being matched such that a voltage between said control terminal and said first terminal of at least one of said stack elements is generally the same as V_{ct};
wherein a first reference voltage (V_{REF}) is input to said reference element; and
wherein a second reference voltage is input to said stack elements.

41. A circuit comprising:
a reference element adapted to receive a first reference voltage and provide a reference current; and
a plurality of series-connected stack elements adapted to receive said reference current and provide a multiple of said first reference voltage, wherein said multiple is a function of the number of said stack elements.

42. The circuit according to claim 41 wherein a second reference voltage is input to said stack elements, said second reference voltage comprising said first reference voltage divided by a voltage divider.

43. The circuit according to claim 42 wherein said second reference voltage is equal to said first reference voltage divided by a predetermined factor Y, and wherein an output OF of said circuit is given by:
OP=(S×V_{REF})+(V_{REF}/Y) wherein S=the number of stack elements.
